(19) United States
(12) Patent Application Publication
(10) Pub. No.: US 2026/0200305 A1
(43) Pub. Date: Jul. 16, 2026

(54) Modular Spaceframe Configurations and Methods

(71) Applicant: BSL CH AG, Chur (CH)

(72) Inventors: Noamaan Siddiqi, Mytchett (GB); Chetna Jain, Mytchett (GB); Lawrence Alger, Mytchett (GB)

(21) Appl. No.: 19/132,753

(22) PCT Filed: Nov. 23, 2023
(86) PCT No.: PCT/IB2023/061850

§ 371 Date: May 23, 2025

Related U.S. Application Data
(60) Provisional application No. 63/427,541, filed on Nov. 23, 2022.
(60) Provisional application No. 63/427,529, filed on Nov. 23, 2022.

(51) Int. Cl. B60K 1/04; B62D 21/02; B62D 21/06

(52) U.S. Cl. CPC B60K 1/04; B62D 21/02; B62D 21/06; B60K 2001/0438

(57) ABSTRACT

A modular spaceframe for a commercial vehicle, which includes a body module comprising a plurality of beams forming a zone of protection therein, within which may be battery packs in certain battery pack configurations, and may be held therein in part by a battery tray, which may form part of a skateboard-type platform. Also, a spaceframe for an autonomous drivable vehicle including a body module and a cockpit module having a driver workplace area that is convertible to a payload area by removing a modular bulkhead structure. Also, a method of modifying a spaceframe for an autonomous driving configuration by removing a modular bulkhead structure between a body module and a cockpit module to create space for an extra payload area and converting the driver workplace area into the extra payload area.

### CROSS-REFERENCE TO RELATED APPLICATIONS

This application claims priority and benefit to U.S. Provisional Application No. 63/427,541, filed on Nov. 23, 2022, and titled “Modular Integration of Battery Pack Configuration for Commercial Vehicle,” and also claims priority to claims priority and benefit to U.S. Provisional Application No. 63/427,529, also filed on Nov. 23, 2022 and entitled “Modular Spaceframe for Autonomous Commercial Vehicle Configuration,” both of which incorporate by reference the U.S. Provisional Application No. 63/333,067 filed on Apr. 20, 2022 and titled “Spaceframe for Commercial Vehicles,” the contents all of which are incorporated by reference herein as though set forth in their entirety.

### FIELD OF USE

The present disclosure relates to, among other things, modularity of spaceframes.

### BACKGROUND

Spaceframe structures are utilized in a number of different fields, including as aircraft, motorsport, or industrial structures. Medium-and heavy-duty commercial vehicles are conventionally built on a so-called ladder frame arrangement.

Available chassis options for commercial vehicles limit accommodation of different vehicle platforms. They do not enable a variety of chassis layouts or configurations. Thus, there is a need to address these deficiencies.

Autonomous vehicles are sometimes known as driverless vehicles. The autonomous vehicle is in its early stages of development. There is a continuous need for research in order to enable autonomous vehicles to be produced on a commercial basis and to compete commercially with existing drive vehicles.

Autonomous vehicles provide better performance than conventional solutions in the market today such as higher availability, lower environmental impact, greater personnel safety, and an increase in up-time and productivity which enables better management and utilization of vehicles. But many current vehicles, including commercial vehicles, are not autonomous and cannot become, or cannot easily become autonomous, due to deficient designs.

### SUMMARY OF THE DISCLOSURE

The following presents a simplified overview of example embodiments in order to provide a basic understanding of some aspects of the invention. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

Aspects of the disclosure relate to chassis layouts or configurations for spaceframes that are more modular in nature. As such embodiments of the disclosure may enable a greater variety of chassis layouts, and be more suitable for different battery pack configurations.

Embodiments of this disclosure include a modular spaceframe for a commercial vehicle. Some embodiments of the modular spaceframe may include a body module comprising a plurality of longitudinal beams, a plurality of lateral beams, and a plurality of vertical beams.

In some embodiments, each of the plurality of longitudinal beams may connected with at least one the plurality of lateral beams and of the plurality of vertical beams. In some embodiments, each of the plurality of lateral beams may be connected with at least one the plurality of longitudinal beams and with at least one of the plurality of vertical beams. And in some embodiments, each of the plurality of vertical beams may be connected with at least one the plurality of longitudinal beams and with at least one of the plurality of lateral beams.

And in some embodiments, the pluralities of interconnected longitudinal beams, lateral beams, and vertical beams may be configured to form one or more zones of protection laterally interior to the body module. In addition, the one or more zones of protection may provide support for integration of a battery pack configuration within the one or more zones of protection.

In some spaceframe embodiments, the pluralities of interconnected longitudinal beams, lateral beams, and vertical beams may configured to form the one or more zones of protection longitudinally interior to the body module.

In some spaceframe embodiments, the body module further includes a battery tray tailored to the battery pack configuration and for placement of one or more battery packs thereon while holding the one or more battery packs within the one or more zones of protection.

In some spaceframe embodiments, the body module further includes a mid-module and rear module, and the one or more zones of protection have at least a first zone of protection located in the mid-module, and at least a second zone of protection located in the rear-module.

In some spaceframe embodiments, the mid-module includes the battery tray. In some spaceframe embodiments, the rear-module includes the battery tray. In some spaceframe embodiments, the battery tray includes two or more battery trays with at least one battery tray corresponding to the mid-module and at least one battery tray corresponding to the rear-module. In some spaceframe embodiments, the battery tray forms an integral structural part of the spaceframe. In some spaceframe embodiments, the battery tray forms a skateboard-shaped platform configured to increase at least one of the compression strength or shear strength of the spaceframe.

In some spaceframe embodiments, the one or more zones of protection are modular to facilitate the integration of different types of battery pack configurations. In some spaceframe embodiments, the plurality of longitudinal beams are laterally spaced from each other, and the plurality of lateral beams are longitudinally spaced from each other.

Some spaceframe embodiments, include a cockpit module anterior to the body module, having one or more cockpit zones of protection. In some spaceframe embodiments, the cockpit module includes a cockpit battery tray tailored to a cockpit battery pack configuration, which forms an integral structural part of the spaceframe.

Also described herein are embodiments for a spaceframe for an autonomous drivable vehicle. Some such autonomous vehicle spaceframe embodiments may include a body module, a cockpit module anterior to the body module, wherein the cockpit module comprises a driver workplace area for a non-autonomous vehicle configuration that is convertible to a payload area for an autonomous vehicle configuration, and a removable modular bulkhead structure between the body module and the cockpit module, wherein the removable modular bulkhead structure is removable for the autonomous vehicle configuration.

In some autonomous vehicle spaceframe embodiments, the removable modular bulkhead structure includes one or more removable longitudinal beams, or more removable vertical beams, or more removable lateral beams required to be removed for the autonomous vehicle configuration.

In some such autonomous vehicle spaceframe embodiments, the removable modular bulkhead structure includes one or more removable longitudinal beams and one or more removable vertical beams and more removable lateral beams required to be removed for the autonomous vehicle configuration.

In some such autonomous vehicle spaceframe embodiments, the cockpit module includes a plurality of beams that remain part of the cockpit module for the autonomous vehicle configuration.

Also described herein are embodiments of a method of modifying a spaceframe for an autonomous driving configuration. Some method embodiments may include the step of providing a removable modular bulkhead structure between a body module and a cockpit module, wherein the cockpit module comprises a driver workplace area.

Some method embodiments may include the step of removing the removable modular bulkhead structure between the body module and the cockpit module to create space for a first part of an extra payload area.

And some method embodiments may include the step converting the driver workplace area into a second part of the extra payload area.

Some method embodiments may include, whether as part of one of the aforementioned steps, or on its own, a step of removing the one or more removable longitudinal beams and the one or more removable vertical beams, and the one or more removable lateral beams without removing the plurality of cockpit beams.

Still other advantages, embodiments, and features of the subject disclosure will become readily apparent to those of ordinary skill in the art from the following description wherein there is shown and described a preferred embodiment of the present disclosure, simply by way of illustration of one of the modes best suited to carry out the subject disclosure. As will be realized, the present disclosure is capable of other different embodiments and its several details are capable of modifications in various other embodiments all without departing from, or limiting, the scope herein.

Also described herein are embodiments of a spaceframe for commercial vehicle that includes a body module which is comprised of a mid-module and rear module which facilitates the integration of different types of battery pack configurations. The body module consists of a plurality of laterally spaced, longitudinally extending side beams and upright beams, each being connected to a respective side beam and extending upwardly to form a modular zone to provide support for integration of different battery pack configurations.

In some spaceframe embodiments, the mid-section consists of a plurality of laterally spaced, longitudinally extending side beams and upright beams, each being connected to a respective side beam and extending upwardly to form a modular zone as described herein, and with reference to the accompanying drawings. The modular zone can be used for multiple battery pack configurations, which provides modularity for different combinations of battery packs with ease, to fit within crash-protected zones with minimal changes to the spaceframe and provide a tailored configuration for customers depending on their range, pay load, and charging needs.

In some spaceframe embodiments, the rear section consists of a plurality of laterally spaced, longitudinally extending side beams and upright beams, each being connected to a respective side beam and extending upwardly to form a modular zone as described herein, and with reference to the accompanying drawings. The modular zone can be used for multiple battery pack configurations, which provides modularity for different combinations of battery packs with ease, to fit within crash-protected zones with minimal changes to the spaceframe and provide a tailored configuration for customers depending on their range, pay load, and charging needs.

In some spaceframe embodiments, in the mid-section zone, the battery tray acts as an integral structural part of the spaceframe to create a skateboard-type of platform which provides additional strengths/rigidity properties to the spaceframe as described herein, and with reference to the accompanying drawings.

In some spaceframe embodiments, in the rear-section zone, the battery tray acts as integral structural part of the spaceframe to create a skateboard-type of platform which provides additional strengths/rigidity properties to spaceframe as described herein, and with reference to the accompanying drawings.

Some spaceframe examples for commercial vehicle includes a body module and a cockpit module (incorporating front module). The body module consists of a plurality of laterally spaced, longitudinally extending side beams to a B-pillar-forming section and a plurality of upright beams, each being connected to a respective side beam and extending upwardly to form a pair of rear pillars. The body module is divided into several modules such as a mid-module, a rear module, upper module, and a wheel arch module for modularity of the spaceframe. The mid-section and rear section of the body module can be used for multiple battery pack configurations, which provides flexibility for different combinations of battery packs with ease, to fit within crash-protected zones with minimal changes to the spaceframe. It also provides a tailored configuration for customer depending on their range, pay load, and charging needs. Battery pack configurations inversely varies with pay load, i.e., the lower the range, the lesser battery pack requirements, resulting in higher pay load. The spaceframe is capable of integrating battery packs to use them as structural parts of the frame to create a skateboard-type of platform—a unique concept for commercial vehicle.

Also described herein are embodiments of a spaceframe for commercial vehicle without driver's workplace area and combining the body module and cockpit module (incorporating front module) by removing bulkhead structure which provides skateboard kind of platform for autonomous vehicle configuration.

In some embodiments, a skateboard-type of platform facilitates increased loading platform as described herein and with reference to the accompanying drawings for autonomous vehicle configuration.

In some spaceframe examples, a spaceframe for commercial vehicle includes a body module and a cockpit module (incorporating front module). The body module and cockpit module (incorporating front module) consist of a plurality of laterally spaced, longitudinally extending side beams and a plurality of upright beams, each being connected to a respective side beam. The body module and cockpit module (incorporating front module) are further separated from each other by means of bulkhead structure. The spaceframe has adequate flexibility to remove bulkhead structure, which in turn creates a skateboard-type of platform to allow for easy transition into autonomous vehicles which provides a tailored configuration for the customer. The new degrees of freedom in spaceframes enables new and flexible autonomous vehicle concepts, making transportation more efficient and profitable.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. The drawings do not illustrate all embodiments. Other embodiments may be used in addition or instead. In certain instances, details that are not necessary for an understanding of the disclosure or that render other details difficult to perceive may have been omitted. Some embodiments may be practiced with additional components or steps and/or without all of the components or steps that are illustrated. When the same numeral appears in different drawings, it refers to the same or like components or steps.

FIG. 1 is a perspective view of a modular spaceframe embodiment, in accordance with aspects of the disclosure.

FIG. 2 is a perspective view of a modular spaceframe embodiment, in accordance with aspects of the disclosure.

FIG. 3 is a perspective sectional view of a modular spaceframe embodiment, in accordance with aspects of the disclosure.

FIG. 4 is an exploded view of battery pack configurations for a modular spaceframe embodiment, in accordance with aspects of the disclosure.

FIG. 5 is a perspective sectional view of a modular spaceframe embodiment, in accordance with aspects of the disclosure.

FIG. 6 is a perspective sectional view of a modular spaceframe embodiment, in accordance with aspects of the disclosure.

FIG. 7 is a sectional top view of a modular spaceframe embodiment, in accordance with aspects of the disclosure.

FIG. 8 is a sectional top view of a modular spaceframe embodiment, in accordance with aspects of the disclosure.

FIG. 9 is a flow diagram generally illustrating a method of modifying a spaceframe for an autonomous driving configuration, in accordance with aspects of the disclosure.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

It is to be noted that terms “upper”, “lower”, “front”, “rear”, and the like are made with reference to the accompanying drawings, or in the state that the battery pack configurations are integrated to the vehicle spaceframe 1, which is in a steady state for running, in which travelling direction is mentioned as “front” or “forward”.

A spaceframe is a cage-like structure and truss (multi-interconnecting beams which can then be regarded as “3-dimensional”) that provides strength and support for multi-directional forces, which improves performance in a vehicle. As explained below, a modular spaceframe can offer benefits over existing spaceframes. For example, modular spaceframe designs may offer new degrees of freedom in spaceframes, enabling new and flexible vehicle concepts that make transportation more efficient and profitable, and/or providing an increased load carrying capacity. For instance, some modular spaceframe examples may offer more efficient use of space for autonomous vehicles (including for commercial vehicle spaceframes being converted into autonomous vehicles). Some modular spaceframe embodiments may provide a skateboard-type platform that may assist in carrying and storing battery packs so as to allow an increased payload.

In addition, some modular spaceframe embodiments may be configured to more effectively protect battery packs from multi-directional forces. Relatedly, it is an objective of the disclosure to provide modularity of battery pack configurations for commercial vehicles using spaceframes. Another objective of the disclosure is to provide the integration of battery packs to use them as structural parts of the frame to create a skateboard kind of platform—a unique concept for commercial vehicles which provides additional strengths/rigidity properties to spaceframes.

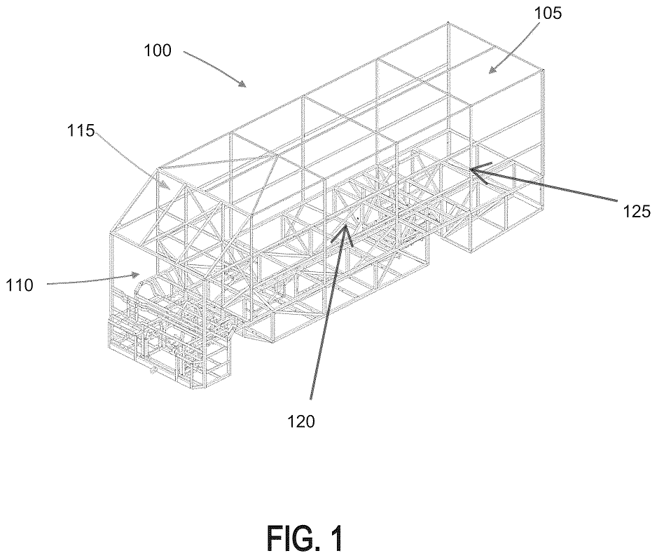

FIG. 1 is a perspective view of a modular spaceframe embodiment 100, in accordance with aspects of the disclosure. In some examples, the modular spaceframe embodiment may be for commercial vehicle application. The modular spaceframe embodiment 100 includes a body module 105 and a cockpit module 110. In some examples, the cockpit module 110 may incorporate a front module. The modular spaceframe embodiment 100 may also include a bulkhead structure 115, separating the body module 105 and cockpit module 110 (incorporating a front module).

In some embodiments, the body module 105 and cockpit module 110 (incorporating front module) may consist of a plurality of laterally spaced, longitudinally extending side beams 120 and a plurality of upright beams 125, each being connected to a respective side beam 120. In some embodiment, the side beams 120 may include longitudinal beams and lateral beams.

In some embodiments, the body module 105 and cockpit module 110 (incorporating front module) are further separated from each other by means of bulkhead structure 115. Some examples, such as the modular spaceframe embodiment 100, and as further explained below, may have adequate flexibility to remove bulkhead structure 115. Such removal may be part of a tailored configuration that in turn may allow for easy transition into autonomous vehicles.

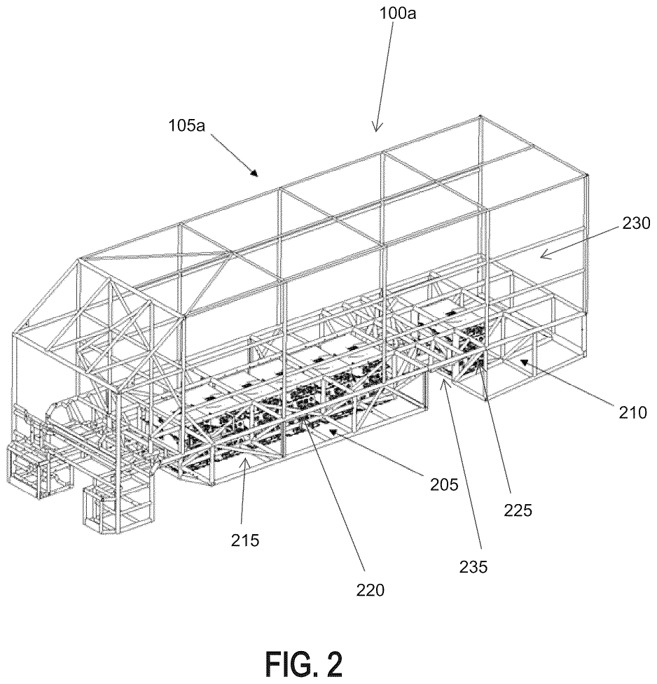

FIG. 2 is a perspective view of a modular spaceframe embodiment 100a, in accordance with aspects of the disclosure. In some examples, the modular spaceframe embodiment 100a may facilitate integration of different battery pack configurations, e.g., to meet needs identified for commercial vehicle spaceframes.

FIG. 2 illustrates the modular spaceframe embodiment 100a with a body module 105a that includes a mid-section 205 (or mid-module) and a rear section 210 (or rear-module). The mid-section 205 (or mid-module) and a rear section 210 (or rear-module) may include or be formed of structural members connected to each other at nodes and/or joints. The structural members can include hollow tubes and/or solid tubes, and in some instances can be connected according to structural triangulation. It may further be reinforced with plates and/or sheets. These structural members, plates, and/or sheets can be made of metal, metal alloys, or reinforced composite materials for instance.

In some examples shown herein, such features may be used for different types of battery pack configuration integration. For example, the modular spaceframe embodiment 100a and body module 105a thereof may provide modularity for different combinations of battery pack configurations within crash-protected zones. In this embodiment, different battery pack configurations are connected to the modular spaceframe embodiment 100a with high strength bolted joints. Other connections may also be used. In some instances, this may all be achieved with minimal changes to the spaceframe. Such modularity may also provide a tailored configuration for customers depending on their range, pay loads and charging needs. Battery pack configuration inversely varies with pay load, i.e., the lower the range, the lesser battery pack requirements, resulting in higher pay load.

Some embodiments of the disclosure provide spaceframe capabilities of integrating battery pack configurations to use them as structural parts of the frame to create a skateboard-type of platform 215—a unique concept for commercial vehicles which provides additional strengths/rigidity properties to a spaceframe.

In some embodiments, the mid-module or mid-section 205 consists of a plurality of laterally spaced, longitudinally extending side beams and upright beams, each being connected to a respective side beam and extending upwardly to form a modular zone 220 as described herein, and with reference to the accompanying drawings. The aforementioned zone 220 can be used for multiple battery pack configurations, which provides modularity for different combinations of battery packs with ease, to fit within crash-protected zones with minimal changes to the spaceframe and provide a tailored configuration for customers depending on their range, pay load, and charging needs.

In some embodiments, the rear-module or rear-section 210 also consists of a plurality of laterally spaced, longitudinally extending side beams and upright beams, each being connected to a respective side beam and extending upwardly to form another modular zone 225 as described herein, and with reference to the accompanying drawings. The aforementioned other or second zone 225 can also be used for multiple battery pack configurations, which provides modularity for different combinations of battery packs with ease, to fit within crash-protected zones with minimal changes to the spaceframe and provide a tailored configuration for customers depending on their range, pay load, and charging needs.

In some examples, the body module 105a consists of a plurality of laterally spaced, longitudinally extending side beams to a B-pillar-forming section and a plurality of upright beams, each being connected to a respective side beam and extending upwardly to form a pair of rear pillars. In some embodiments, the body module 105a is divided into several modules such as a mid-module 205, a rear module 210, upper module 230, and a wheel arch module 235 for modularity of the spaceframe.

As explained above, the mid-section 205 and rear section 210 of the body module 105a can be used for multiple battery pack configurations, which provides flexibility for different combinations of battery packs with ease, to fit within crash-protected zones with minimal changes to the spaceframe. It also provides a tailored configuration for different customers depending on their range, pay load, and charging needs. Battery pack configurations often inversely vary with pay load, i.e., the lower the range, the lesser battery pack requirements, resulting in higher pay load.

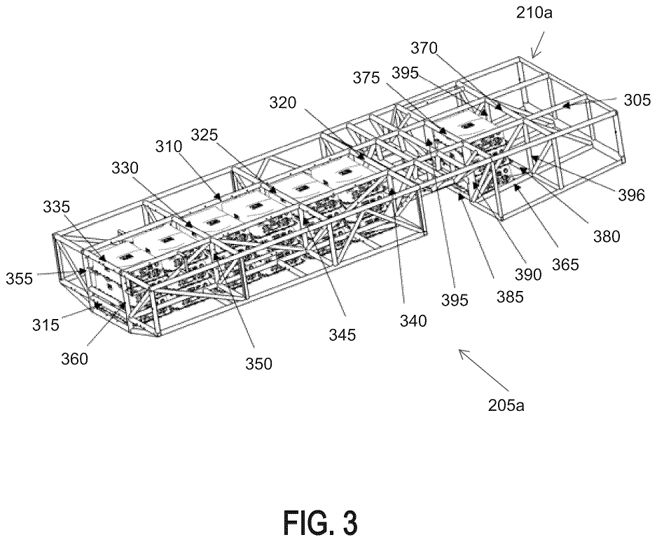

FIG. 3 is a perspective sectional view of a modular spaceframe embodiment 100, in accordance with aspects of the disclosure. More specifically, FIG. 3 is a more detailed sectional view from a perspective as viewed from a left forward side.

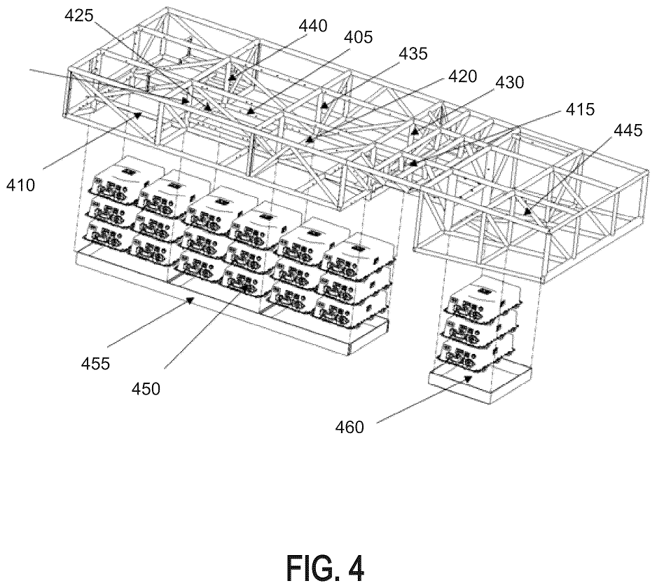

FIG. 4 is an exploded view of battery pack configurations for a modular spaceframe embodiment, in accordance with aspects of the disclosure. FIG. 4 shows battery pack configurations with modular spaceframe embodiment 100, as viewed from left rearward side.

Longitudinal structural members (or beams) 305, 310, 405, 410, lateral members 415, 420, 425, 315, 320, 325, 330, 335, and vertical members 340, 345, 350, 430, 435, 440, 355, 360 of mid-section 205a forms a modular zone to provide support for integration of different battery pack configurations.

Longitudinal structural members 305, 310, 365, 445, lateral members 370, 375, 380, 385 and vertical members 390, 295, 395, 396 of rear section 210a further forms a modular zone to provide support for integration of different battery pack configurations.

FIG. 4 further illustrates an embodiment of battery configurations 450 and battery tray 455 and 460 connections with a vehicle spaceframe such as modular spaceframe embodiment 100. The battery tray 455 may be an integral structural part of a spaceframe to create a skateboard-type of platform, which provides additional strengths/rigidity properties to a spaceframe as described herein, and with reference to the accompanying drawings.

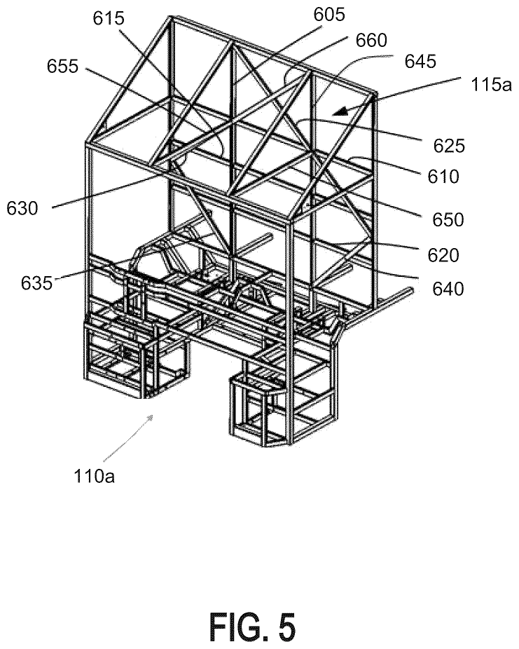

FIG. 5 is a perspective sectional view of a modular spaceframe embodiment, in accordance with aspects of the disclosure. FIG. 5's perspective sectional view may be of modular spaceframe embodiment 100 as viewed from left forward side with a bulkhead structure 115a. FIG. 5 may provide a more detailed sectional view further illustrating an embodiment with current cockpit module (incorporating front module) 110a separated from body module 105 by bulkhead structure 115a.

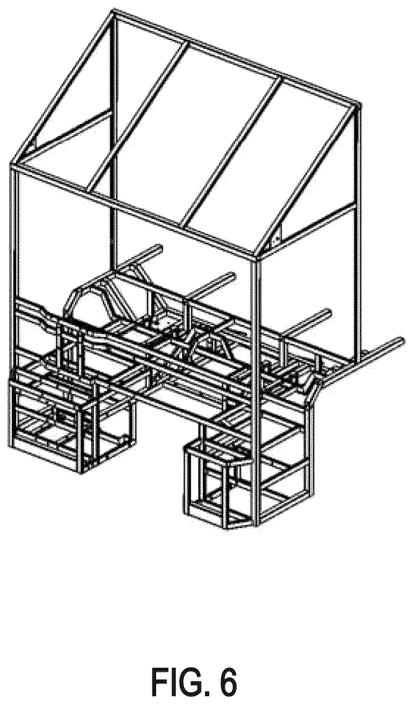

FIG. 6 is a perspective sectional view of a modular spaceframe embodiment, in accordance with aspects of the disclosure. FIG. 6 perspective sectional view may also be of modular spaceframe embodiment 100 as viewed from left forward side but without a bulkhead structure 115a.

The disclosure provides embodiments of modular spaceframe embodiment 100 or that incorporate modularity into a current spaceframe such as a current commercial vehicle spaceframe to meet the needs for easy transition to autonomous vehicle configuration.

As shown in FIG. 5, one or more of the plurality of beams 605, 610, 615, 620, 625, 630, 635, 640, 645 of bulkhead structure 115a and plurality of beams 650, 655, 660 of aerodynamic fairing structure, separating cockpit module (incorporating front module) 110a and body module 105 can be removed to enable its use for easy transition to autonomous vehicle configuration, which in turn provides increased cargo loading platform as shown in FIG. 6 resulting in higher pay-load-to-weight ratio. Spaceframes also allow for different steering configurations (i.e. front, rear or all wheel steering) and even alters between these in different situations and driving directions.

FIG. 6 is a more detailed sectional view which further illustrates an embodiment without bulkhead structure 105. One or more of the plurality of beams 605, 610, 615, 620, 625, 630, 635, 640, 645 of bulkhead structure 105 and plurality of beams 650, 655, 660 of aerodynamic fairing structure, separating cockpit module (incorporating front module) 110a and body module 105 are removed.

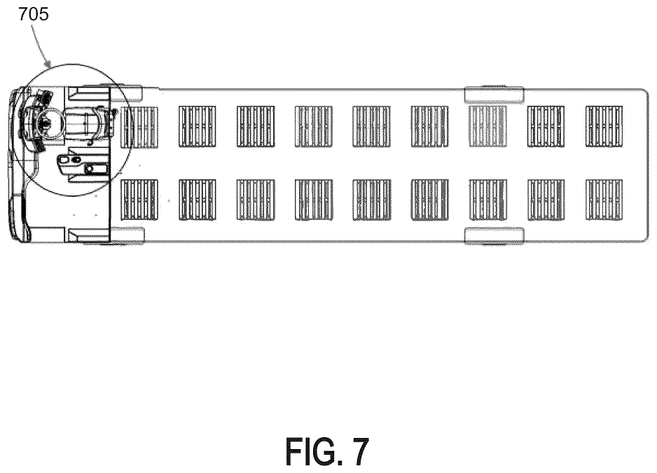

FIG. 7 is a sectional top view of a modular spaceframe embodiment, in accordance with aspects of the disclosure. FIG. 7 is a sectional top view of an embodiment of current spaceframe with bulkhead structure 115a (separating the cockpit module 110a and the body module 105) and with driver's workplace area 305.

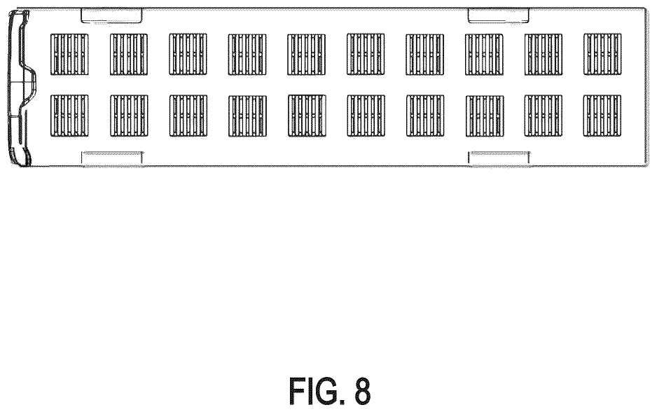

FIG. 8 is a sectional top view of a modular spaceframe embodiment, in accordance with aspects of the disclosure. FIG. 8 is a sectional top view of an embodiment of spaceframe without bulkhead structure 115a and without driver's workplace area 705. As shown in FIG. 8, the removal of the bulkhead structure 115a may enable easy transition to autonomous vehicle configurations which in turns provides increased cargo loading platform.

Relatedly, an autonomous vehicle does not require driver's workplace area 705 which in turn reduces assembly line complexity and quick adoption to different customer demands. In addition, autonomous vehicles no longer need boarding steps for drivers which allows for improved turning clearance circle radius by re-shaping the front panels. Thus, the embodiments of the present disclosure provides spaceframe adaptability for autonomous vehicle configuration.

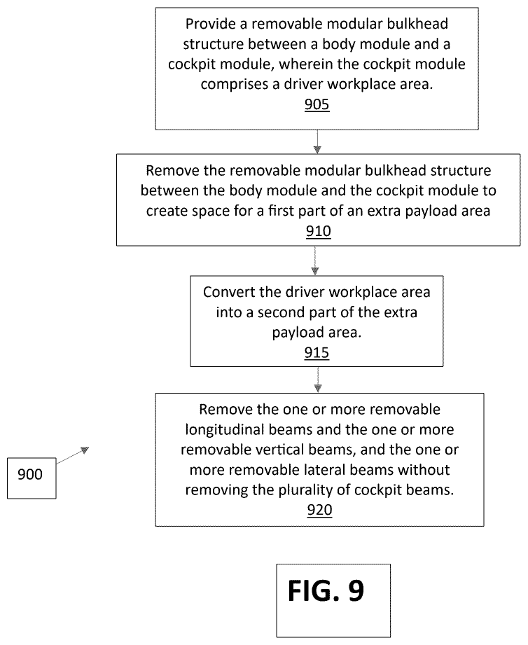

FIG. 9 is a flow diagram generally illustrating a method 900 of modifying a spaceframe for an autonomous driving configuration, in accordance with aspects of the disclosure. Such a method 900 may include providing a removable modular bulkhead structure between a body module and a cockpit module, wherein the cockpit module comprises a driver workplace area 805.

Such method 900 may also include Remove the removable modular bulkhead structure between the body module and the cockpit module to create space for a first part of an extra payload area 910.

In addition, the method 900 may include converting the driver workplace area into a second part of the extra payload area 915.

Further, in some embodiments, the removable modular bulkhead structure may include one or more removable longitudinal beams, and one or more removable vertical beams, and one or more removable lateral beams. And in some embodiments, the cockpit module may include a plurality of cockpit beams, and at least some of the plurality of cockpit beams may be interconnected with at least of some of the one or more removable longitudinal beams, the one or more removable vertical beams, or the more removable lateral beams. And in some such embodiments incorporated by method embodiments such as method 900, the step of removing the removable modular bulkhead structure may include removing the one or more removable longitudinal beams and the one or more removable vertical beams, and the one or more removable lateral beams without removing the plurality of cockpit beams 920.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

These and other features, and characteristics of the present technology, as well as the methods of operation and functions of the related elements of structure and the combination of parts and economies of manufacture, will become more apparent upon consideration of the description herein and the appended claims with reference to the accompanying drawings, all of which form a part of this specification, wherein reference numerals designate corresponding parts in the various figures. It is to be expressly understood, however, that the drawings are for the purpose of illustration and description only and are not intended as a definition of the limits of the disclosure.

1. A modular spaceframe for a commercial vehicle, comprising;
a body module comprising a plurality of longitudinal beams, a plurality of lateral beams, and a plurality of vertical beams,
wherein each of the plurality of longitudinal beams is connected with at least one the plurality of lateral beams and of the plurality of vertical beams, and wherein each of the plurality of lateral beams is connected with at least one the plurality of longitudinal beams and with at least one of the plurality of vertical beams, and wherein each of the plurality of vertical beams is connected with at least one the plurality of longitudinal beams and with at least one of the plurality of lateral beams, and
wherein the pluralities of interconnected longitudinal beams, lateral beams, and vertical beams are configured to form one or more zones of protection laterally interior to the body module, the one or more zones of protection providing support for integration of a battery pack configuration within the one or more zones of protection.

2. The spaceframe of claim 1, wherein the pluralities of interconnected longitudinal beams, lateral beams, and vertical beams are configured to form the one or more zones of protection longitudinally interior to the body module.

3. The spaceframe of claim 1, wherein the body module further comprises a battery tray tailored to the battery pack configuration and for placement of one or more battery packs thereon while holding the one or more battery packs within the one or more zones of protection.

4. The spaceframe of claim 3, wherein the body module comprises a mid-module and rear module and the one or more zones of protection comprise at least a first zone of protection located in the mid-module, and at least a second zone of protection located in the rear-module.

5. The spaceframe of claim 4, wherein the mid-module comprises the battery tray.

6. The spaceframe of claim 4, wherein the rear-module comprises the battery tray.

7. The spaceframe of claim 4, wherein the battery tray comprises two or more battery trays with at least one battery tray corresponding to the mid-module and at least one battery tray corresponding to the rear-module.

8. The spaceframe of claim 4, wherein the battery tray forms an integral structural part of the spaceframe.

9. The spaceframe of claim 8, wherein battery tray forms a skateboard-shaped platform configured to increase at least one of the compression strength or shear strength of the spaceframe.

10. The spaceframe of claim 1, wherein the one or more zones of protection are modular to facilitate the integration of different types of battery pack configurations.

11. The spaceframe of claim 1, wherein the plurality of longitudinal beams are laterally spaced from each other, and the plurality of lateral beams are longitudinally spaced from each other.

12. The spaceframe of claim 11, further comprising:
a cockpit module anterior to the body module, wherein the cockpit module comprises a plurality of cockpit longitudinal beams, a plurality of cockpit lateral beams, and a plurality of cockpit vertical beams,
wherein each of the plurality of cockpit longitudinal beams is connected with at least one the plurality of cockpit lateral beams and of the plurality of cockpit vertical beams, and wherein each of the plurality of cockpit lateral beams is connected with at least one the plurality of cockpit longitudinal beams and with at least one of the plurality of cockpit vertical beams, and wherein each of the plurality of cockpit vertical beams is connected with at least one the plurality of cockpit longitudinal beams and with at least one of the plurality of cockpit lateral beams, and
wherein the pluralities of interconnected cockpit longitudinal beams, lateral cockpit beams, and vertical cockpit beams are configured to form one or more zones of protection laterally interior to the cockpit module, the one or more cockpit zones of protection providing support for integration of a cockpit battery pack configuration within the one or more cockpit zones of protection.

13. The spaceframe of claim 12, wherein the cockpit module further comprises a cockpit battery tray tailored to the cockpit battery pack configuration and for placement of one or more cockpit battery packs thereon while holding the one or more cockpit battery packs within the one or more cockpit zones of protection.

14. The spaceframe of claim 13, wherein the cockpit battery tray forms an integral structural part of the spaceframe and forms a skateboard-shaped platform configured to increase at least one of the compression strength or shear strength of the spaceframe.

15. A spaceframe for an autonomous drivable vehicle, comprising:
a body module;
a cockpit module anterior to the body module, wherein the cockpit module comprises a driver workplace area for a non-autonomous vehicle configuration that is convertible to a payload area for an autonomous vehicle configuration; and
a removable modular bulkhead structure between the body module and the cockpit module, wherein the removable modular bulkhead structure is removable for the autonomous vehicle configuration.

16. The spaceframe of claim 15, wherein the removable modular bulkhead structure comprises one or more removable longitudinal beams, or more removable vertical beams, or more removable lateral beams required to be removed for the autonomous vehicle configuration.

17. The spaceframe of claim 15, wherein the removable modular bulkhead structure comprises one or more removable longitudinal beams and one or more removable vertical beams and more removable lateral beams required to be removed for the autonomous vehicle configuration.

18. The spaceframe of claim 17, wherein the cockpit module comprises a plurality of beams that remain part of the cockpit module for the autonomous vehicle configuration.

19. A method of modifying a spaceframe for an autonomous driving configuration, comprising:
providing a removable modular bulkhead structure between a body module and a cockpit module, wherein the cockpit module comprises a driver workplace area;
removing the removable modular bulkhead structure between the body module and the cockpit module to create space for a first part of an extra payload area; and
converting the driver workplace area into a second part of the extra payload area.

20. The method of claim 19, wherein the removable modular bulkhead structure comprises one or more removable longitudinal beams, and one or more removable vertical beams, and one or more removable lateral beams, and the cockpit module comprises a plurality of cockpit beams, and at least some of the plurality of cockpit beams are interconnected with at least of some of the one or more removable longitudinal beams, the one or more removable vertical beams, or the more removable lateral beams, and wherein removing the removable modular bulkhead structure comprises:
removing the one or more removable longitudinal beams and the one or more removable vertical beams, and the one or more removable lateral beams without removing the plurality of cockpit beams.
